(19) United States
(12) Patent Application Publication
(10) Pub. No.: US 2006/0037318 A1
(43) Pub. Date: Feb. 23, 2006

(54) Method for operating an internal combustion engine

(76) Inventors: Manfred Kloft, Konigslutter (DE); Florian Noodt, Sickte (DE)

Correspondence Address: OSTROLENK FABER GERB & SOFFEN, 1180 AVENUE OF THE AMERICAS, NEW YORK, NY, 100368403, US

(21) Appl. No.: 10/527,229

(22) PCT Filed: Sep. 10, 2003
(86) PCT No.: PCT/EP03/10066

§ 371 Date: Apr. 7, 2005

(30) Foreign Application Priority Data
Sep. 10, 2002 (DE) 102 61 979.4

(51) Int. Cl. F02B 33/44

(52) U.S. Cl. 60/605.2

(57) ABSTRACT

The invention relates to an internal combustion engine, especially an internal combustion engine for a motor vehicle, comprising an air path for intake air wherein a compressor (12), an exhaust gas turbocharger (18) and a throttle valve (22) are arranged. An outlet of the compressor (12) is connected to an inlet of the exhaust gas turbocharger (18). An air channel (14) is provided which bridges over the compressor (12). The throttle valve (22) is arranged downstream from the exhaust gas turbocharger (18). A compression throttle valve (16) is arranged in the air channel (14) which bridges over the compressor (12), said valve selectively continuously closes the air channel (14) which bridges over the compressor (12) and controls compression of the compressor (12). According to the inventive method for operating an internal combustion engine, the compressor is disconnected by fully opening the compression throttle valve and by separating a coupling between the compressor and the crankshaft, when the mass flow, which the exhaust gas compressor pumps as a result of an exhaust gas mass flow m_{abg}, exceeds the pump volume of the compressor.

The invention concerns a method for operating an internal combustion engine, especially an internal combustion engine for a motor vehicle, with a charge air flow path, in which a compressor, an exhaust gas turbocharger, a waste gate, which admits a flow of exhaust gas to a turbine of the exhaust gas turbocharger, and a throttle valve are installed, wherein an outlet of the compressor is connected with an inlet of the exhaust gas turbocharger, an air channel that bypasses the compressor is provided, and the throttle valve is installed downstream of the exhaust gas turbocharger, wherein a compression throttle valve, which is installed in the air channel that bypasses the compressor, selectively closes exclusively this air channel that bypasses the compressor in a continuously variable way and controls compression of the compressor, and wherein, in an engine load or speed range in which the exhaust gas turbocharger alone is not able to apply the desired boost pressure, the compressor is switched on, in accordance with the introductory clause of Claim 1.

In the operation of an internal combustion engine, the task of charge determination is to determine the air mass in the combustion chamber as accurately and dynamically correctly as possible to provide a basis for adjustment of the manipulated variables. There is no direct measurement. The various known measuring principles are more or less accurate due to their indirect measuring method. The most widely used method with a hot-film air flowmeter is dynamically inexact, especially in supercharged engines, due to insufficient proximity to the combustion chamber, since long distances in the air path result in time delays and storage effects. In addition, charge-influencing actuators, such as the charge control valve (LBK), camshaft, tank ventilation, and exhaust gas recycling (EGR), and the components exhaust gas turbocharger (ATL) and compressor have a strong effect on the charge and thus on the manipulated variables of the engine.

EP 0 879 345 B1 describes a supercharged piston engine that has both an exhaust-driven turbocharger and a mechanically motor-driven compressor, whose delivery side is connected with the intake side of the turbocharger. A disengageable clutch is provided between the engine and the mechanical compressor. Depending on the engine speed and the engine load, the clutch between the engine and the mechanical compressor is engaged, and the clutch is blocked if the engine load falls below a predetermined level. If an exhaust gas braking device is actuated, then engagement of the clutch is allowed regardless of whether the engine load is below the predetermined level. Since the mechanical compressor should only be operated at low engine speeds, a switching valve is provided, which actively switches both chargers or actively switches only the turbocharger between the operating modes by closing or connecting the corresponding airways. This switching valve switches only between the air path that runs through the compressor and the air path that bypasses the compressor. Therefore, a second control valve is additionally required, which is used to control the mechanical charger and normally realizes recirculated-air control.

U.S. Pat. No. 4,903,488 discloses an internal combustion engine with a charge air flow path, in which a compressor, an exhaust gas turbocharger, and a throttle valve are installed, wherein an outlet of the compressor is connected with an inlet of the exhaust gas turbocharger, and the throttle valve is installed downstream of the exhaust gas turbocharger. A compression throttle valve, which is installed in an air channel that bypasses the compressor, selectively closes exclusively this air channel that bypasses the compressor.

U.S. Pat. No. 6,205,787 discloses a charge air system for an internal combustion engine with a compressor and with an exhaust gas turbocharger, which is additionally provided with an electric motor. To accelerate the internal combustion engine, the charge air compression can be temporarily increased, even at low speeds of the internal combustion engine, by means of the electric motor in the exhaust gas turbocharger. However, as soon as the exhaust gas turbocharger produces a sufficient boost pressure, the electric motor and the compressor are shut off. During an acceleration phase or even at high engine speeds and loads, this boost function of the exhaust gas turbocharger can be used simultaneously with the compressor. A check valve in an air conduit that bypasses the compressor prevents throttling of the exhaust gas turbocharger in every operating situation.

The objective of the present invention is to improve a twin supercharged internal combustion engine of the aforementioned type with respect to the control process.

In accordance with the invention, this objective is achieved by a method of the aforementioned type with the features specified in the characterizing clause of Claim 1. Advantageous refinements of the invention are specified in the dependent claim.

For this purpose, in a method of the aforementioned type, the invention provides that in this engine load or speed range in which the exhaust gas turbocharger alone is not able to apply the desired boost pressure, the compression of the compressor is controlled by the compression throttle valve, and the waste gate is adjusted to maximum compression of the exhaust gas turbocharger.

This has the advantage that in the engine load or speed range in which the exhaust gas turbocharger alone is not able to apply the desired boost pressure, the total amount of air to be delivered by the exhaust gas turbocharger and compressor is controlled exclusively and thus responsively via the compressor by means of the compression throttle valve.

It is advantageous for the compressor to be shut off as soon as the mass flow that the exhaust gas turbocharger is able to deliver on the basis of the exhaust gas mass flow \dot{m}_{abg} supplied by the engine exceeds the delivery volume of the compressor.

Additional features, advantages and advantageous refinements of the invention are specified in the dependent claims and are explained in the following description of the invention with reference to the attached drawing. The sole FIGURE is a schematic representation of the air path and the exhaust gas end of a twin supercharged internal combustion engine.

As the sole FIGURE shows, the internal combustion engine comprises an air path, in which the following are installed: an air filter 10, a compressor 12, an air channel 14 that bypasses the compressor 12, a compression throttle valve 16 for selectively closing the air channel 14, an exhaust gas turbocharger 18, a supercharger intercooler 20, a throttle valve 22, and an intake manifold 24, which opens into the several combustion chambers in a cylinder crankcase 26 of the internal combustion engine. A waste gate 30, which admits a flow of exhaust gas to a turbine 32 of the exhaust gas turbocharger 18, is installed on the exhaust manifold 28. The exhaust gas turbocharger 18 also includes a compressor 33. An outlet of the compressor 12 opens into an inlet of the exhaust gas turbocharger 18. The compressor 12 is driven by a belt 34 from the crankshaft of the internal combustion engine. In this regard, the drive of the compressor 12 can be selectively disengaged from the crankshaft by means of a clutch 36, for example, a magnetic clutch. The concept of this system is to realize supercharging by the compressor 12 in a low engine speed range and to shut off the compressor 12 starting at a certain engine speed, above which the exhaust gas turbocharger 18 guarantees sufficient supercharging. Sensors 38, 40, 42, and 44 measure, respectively, a pressure p_{vATL} before the exhaust gas turbocharger, a pressure p_{vDK} before the throttle valve 22, a pressure pₛ in the intake manifold 24, and an ambient pressure pᵤ.

In the engine load or speed range in which the exhaust gas turbocharger 18 alone is not able to apply the desired boost pressure, the compressor 12 is switched on. Its compression is controlled by the compression throttle valve 16. In this range, the waste gate 30 adjusts to maximum compression of the exhaust gas turbocharger 18. In this regard, the throttle valve 22 acts as the control element of the intake manifold pressure pₛ. The positions of the two valves 16 and 22 are computed in the above-described mass flow model by reverse computation and controlled in a coordinated way. As soon as the mass flow that the exhaust gas turbocharger 18 is able to deliver on the basis of the exhaust gas mass flow \dot{m}_{abg} exceeds the delivery volume of the compressor or as soon as the desired boost pressure can be adjusted by the exhaust gas turbocharger 18 alone, the compressor 12 is shut off. The compression throttle valve 16 is fully opened so as not to throttle the exhaust gas turbocharger 18. The compression of the exhaust gas turbocharger is regulated from this point on by the position of the waste gate valve 30. When the internal combustion engine is running at full load, the throttle valve 22 is completely open, the compressor 12 is coupled, and the compression throttle valve 16 is completely closed. As soon as the exhaust gas turbocharger 18 begins to exhaust the volume after the compressor 12, the waste gate control takes over the adjustment of the desired charge until the desired charge has been reached. Up until this point, the throttle valve 22 is completely open.

1-2. (canceled)

3. A method for operating an internal combustion engine having a charge air flow path in which a compressor, an exhaust gas turbocharger, a waste gate which admits a flow of exhaust gas to a turbine of the exhaust gas turbocharger, and a throttle valve are installed, wherein an outlet of the compressor is connected with an inlet of the exhaust gas turbocharger, an air channel that bypasses the compressor is provided, and the throttle valve is installed downstream of the exhaust gas turbocharger, the method comprising the steps of: selectively closing exclusively the air channel that bypasses the compressor in a continuously variable manner and controlling compression of the compressor with a compression throttle valve which is installed in the air channel that bypasses the compressor; switching on the compressor, in an engine load or speed range in which the exhaust gas turbocharger alone is not able to apply a desired boost pressure; and, in the engine load or speed range in which the exhaust gas turbocharger alone is not able to apply the desired boost pressure, controlling the compression of the compressor with the compression throttle valve, and adjusting the waste gate to maximum compression of the exhaust gas turbocharger.

4. The method in accordance with claim 3, further including shutting off the compressor as soon as the mass flow that the exhaust gas turbocharger is able to deliver based on exhaust gas mass flow \dot{m}_{abg} supplied by the engine exceeds a delivery volume of the compressor.
